(19) United States
(12) Patent Application Publication
(10) Pub. No.: US 2013/0091393 A1
(43) Pub. Date: Apr. 11, 2013

(54) TRANSMISSION TEST DEVICE AND TRANSMISSION TEST METHOD

(71) Applicant: Tatsuki KOBAYASHI, Kawasaki (JP)

(72) Inventor: Tatsuki KOBAYASHI, Kawasaki (JP)

(73) Assignee: FUJITSU LIMITED, Kawasaki-shi (JP)

(21) Appl. No.: 13/584,868

(22) Filed: Aug. 14, 2012

(30) Foreign Application Priority Data
Oct. 7, 2011 (JP) 2011-223481

(51) Int. Cl. G06F 11/263

(52) U.S. Cl. 714/712; 714/E11.177

(57) ABSTRACT

A transmission test device that performs a transmission test in a transmission path includes a determining unit and a killer pattern transfer unit. The determining unit acquires an abnormality incidence rate representing a rate of abnormality having occurred in test data in a transmission path, and determines whether or not the abnormality incidence rate is lower than a predetermined reference value. The killer pattern transfer unit changes the test data and transmits changed test data when the determining unit determines that the abnormality incidence rate is lower than the predetermined reference value.

### CROSS-REFERENCE TO RELATED APPLICATION

This application is based upon and claims the benefit of priority of the prior Japanese Patent Application No. 2011-223481, filed on Oct. 7, 2011, the entire contents of which are incorporated herein by reference.

### FIELD

The embodiments discussed herein are related to a transmission test device, a transmission test method, and a transmission test program.

### BACKGROUND

A SerDes (Serializer Deserializer) circuit converts parallel signals input from a logic circuit into serial signals, and outputs the serial signals to a transmission path. Further, the SerDes circuit converts serial signals input from the transmission path into parallel signals, and outputs the parallel signals to the logic circuit.

In the SerDes circuit, a transmission test to check whether or not data is normally input or output is conducted. For example, the SerDes circuit continuously outputs a data array called a killer pattern to a transmission path during a predetermined time, and measures the rate of bit errors (hereinafter, referred to as a “BER (Bit Error Rate)” value) that have occurred in output data. Then, when a measured BER value is larger than a BER reference value which is a threshold value, the SerDes circuit determines that the transmission path is abnormal.

Further, the SerDes circuit includes a scramble conversion mechanism that converts a specific killer pattern among killer patterns into a stable data pattern. For this reason, when the specific killer pattern is output to the transmission path, the SerDes circuit lowers the BER value through the scramble conversion mechanism. Here, transition of a BER value in scramble conversion will be described with reference to FIG. 10.

FIG. 10 is a diagram illustrating an example of transition of a BER value in scramble conversion. FIG. 10, a horizontal axis represents a cumulative transfer amount of a killer pattern, and a vertical axis represents a BER value. FIG. 10 will be described in connection with an example in which a killer pattern A is continuously output to a transmission path during a predetermined time.

In the example illustrated in FIG. 10, the SerDes circuit determines that a BER1 which is a BER value of the killer pattern A is larger than a BER reference value up to a point in time when the cumulative transfer amount of the killer pattern A becomes 10a. In this case, the SerDes circuit converts the killer pattern A into a stable data pattern through scramble conversion. As a result, the BER value of data output to the transmission path is lowered depending on the cumulative transfer amount.

For this reason, the SerDes circuit continuously outputs a killer pattern, which has not been converted into a stable pattern by the scramble conversion mechanism, other than the specific killer pattern to the transmission path during a predetermined time, and measures the BER value during a predetermined time. Then, when the measured BER value is higher than the reference value, the SerDes circuit is determined as a defective product.

Further, disclosed are techniques related to a transmission test of outputting test data which becomes a worst case for a specific circuit at a reception side or a transmission test of selecting test data according to the purpose from among a plurality of test data and outputting the selected test data.

Patent Literature 1: Japanese Laid-open Patent Publication No. 4-312092

Patent Literature 2: Japanese Laid-open Patent Publication No. 2007-174135

However, in the above-described related art, it is difficult to continuously incur an error in the transmission path.

Inside the SerDes circuit of the related art, all of existing killer patterns are converted into stable patterns through the scramble conversion mechanism. For this reason, even when the killer patterns continuously flow, the SerDes circuit converts the killer patterns into the stable patterns. For this reason, it is difficult for the SerDes circuit to continuously output the killer patterns to the transmission path during a predetermined time. As a result, since there is no difference between a BER value of a normal product and a BER value of a defective product during a predetermined time, there is a problem in that it is difficult to determine a defective product by a transmission test.

### SUMMARY

According to an aspect of an embodiment, a transmission test device that performs a transmission test in a transmission path, comprises a memory and a processor coupled to the memory, wherein the processor executes a process comprise that acquires an abnormality incidence rate representing a rate of abnormality having occurred in test data in a transmission path; and that determines whether or not the abnormality incidence rate is lower than a predetermined reference value; and that changes the test data when it is determined that the abnormality incidence rate is lower than the predetermined reference value; and that transmits the changed test data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of a transmission test device according to a first embodiment;

FIG. 2 is a diagram illustrating an example of information stored in a data pattern holding table;

FIG. 3 is a diagram illustrating an example of information stored in a killer pattern holding table;

FIG. 4 is a flowchart illustrating a processing procedure of a continuation test process of a killer pattern performed by the transmission test device according to the first embodiment;

FIG. 5 is a flowchart to describe a processing procedure of a killer pattern change process performed by the transmission test device according to the first embodiment;

FIG. 6 is a diagram illustrating an example of a relation between transition of a BER value in scramble conversion and a killer pattern change process;

FIG. 7 is a flowchart illustrating a processing procedure of a killer pattern extracting process performed by a transmission test device according to a second embodiment;

FIG. 8 is a flowchart illustrating a processing procedure of processing performed by a transmission test device according to a third embodiment;

FIG. 9 is a diagram illustrating an example of a computer that executes a transmission test program; and

FIG. 10 is a diagram illustrating an example of transition of a BER value in scramble conversion.

### DESCRIPTION OF EMBODIMENTS

Preferred embodiments of the present invention will be explained with reference to accompanying drawings.

The invention is not limited to the following embodiments. The embodiments may be appropriately combined in a range in which processing contents are not in conflict.

### [a] First Embodiment

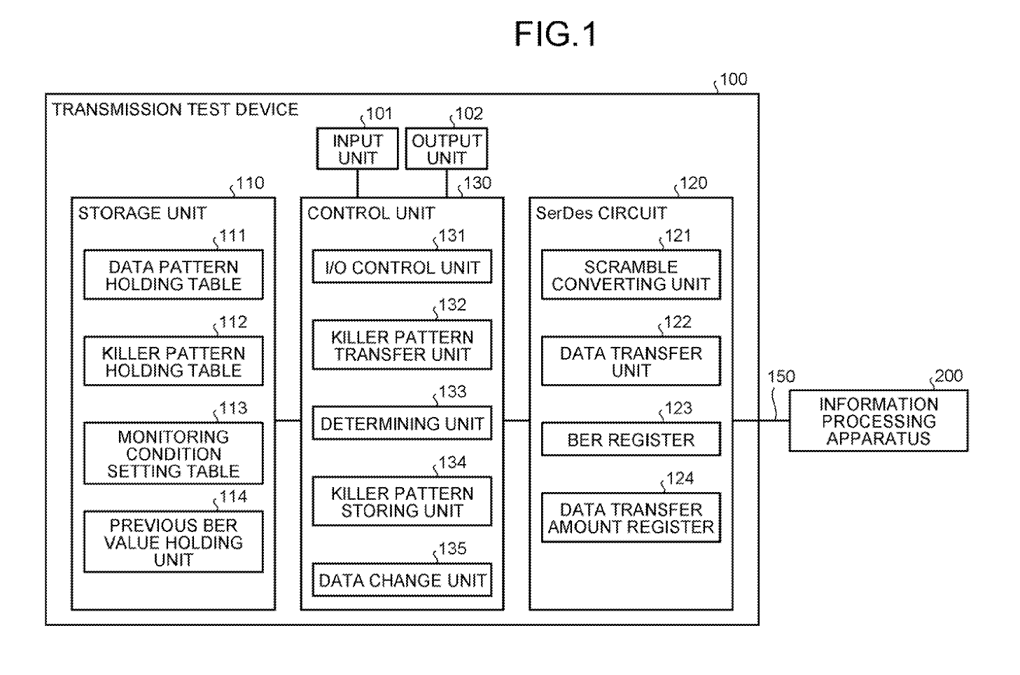

A first embodiment will be described in connection with an example of a transmission test device that executes a transmission test in a transmission path with a communication destination device using a killer pattern whose BER value is known. In the following, a configuration of a transmission test device, the flow of processing performed by a transmission test device, effects, and the like will be described with reference to FIGS. 1 to 6.

Configuration of Transmission Test Device According to First Embodiment

FIG. 1 is a block diagram illustrating a configuration of a transmission test device according to the first embodiment. As illustrated in FIG. 1, a transmission test device 100 includes an input unit 101, an output unit 102, a storage unit 110, a SerDes (Serializer Deserializer) circuit 120, and a control unit 130. The transmission test device 100 is connected with an information processing apparatus 200 of a communication destination through a bus 150.

The input unit 101 includes, for example, a mouse, a keyboard, a touch panel, and the like, and receives an input of various setting conditions and outputs the received various setting conditions to an I/O control unit 131 which will be described later. The output unit 102 is an output device that outputs various pieces of information output by the I/O control unit 131 and includes, for example, an image display device such as a display device or an image forming apparatus such as a printer.

For example, the storage unit 110 is a storage device such as a semiconductor memory device, and includes a data pattern holding table 111, a killer pattern holding table 112, a monitoring condition setting table 113, and a previous BER value holding unit 114.

The data pattern holding table 111 stores a data pattern which the transmission test device 100 uses for a transmission test. Further, the data pattern holding table 111 according to the first embodiment stores a killer pattern, such as a CJPAT pattern or a GPAT pattern, which produces a high frequency or a low frequency on a transmission path between the transmission test device 100 and the information processing apparatus 200. Further, the data pattern holding table 111 according to the first embodiment stores a killer pattern, such as an all-5 pattern, an all-A pattern, an all-zero pattern, an all-F pattern, and a random pattern, which is focused on a bit pattern.

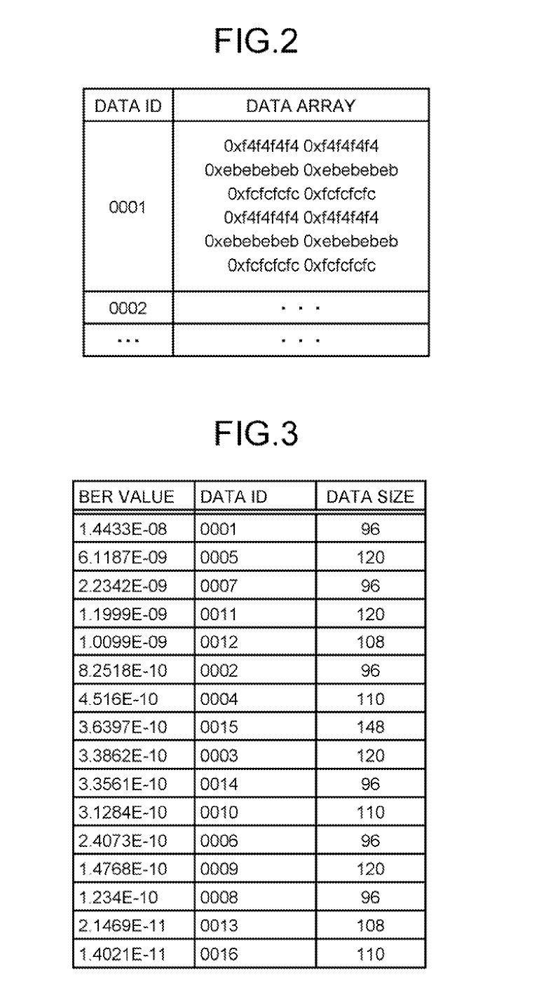

An example of information stored in the data pattern holding table 111 will be described with reference to FIG. 2. FIG. 2 is a diagram illustrating an example of information stored in the data pattern holding table. As illustrated in FIG. 2, for example, the data pattern holding table 111 stores “data ID” and “data array” in association with each other.

The “data ID” stored in the data pattern holding table 111 is an identifier uniquely identifying data. For example, “0001,” “0002,” and the like are stored in “data ID.”

The “data array” stored in the data pattern holding table 111 represents an array of data patterns corresponding to the data ID. For example, array data including two data patterns of “0xf4f4f4f4 0xf4f4f4f4 0xebebebeb 0xebebebeb 0xfcfcfcfc 0xfcfcfcfc” is stored in the “data array.”

In the example illustrated in FIG. 2, “0xf4f4f4f4 0xf4f4f4f4 0xebebebeb 0xebebebeb 0xfcfcfcfc 0xfcfcfcfc” is repeated once in the “data array” having the “data ID” of “0001.”

The killer pattern holding table 112 stores information in which the “BER value,” the “data ID,” and the “data size” are associated with one another on the data pattern stored in the data pattern holding table 111. Here, the killer pattern holding table 112 according to the first embodiment is described to store information in which the “BER value,” “the data ID,” and the “data size” are associated with one another on all of the data patterns stored in the data pattern holding table 111.

An example of information stored in the killer pattern holding table 112 will be described with reference to FIG. 3. FIG. 3 is a diagram illustrating an example of information stored in the killer pattern holding table. As illustrated in FIG. 3, for example, the killer pattern holding table 112 stores the “BER value,” the “data ID,” and the “data size” in association with one another. The killer pattern holding table 112 stores data in descending order of the “BER value.”

Here, the “data ID” stored in the killer pattern holding table 112 is an identifier uniquely identifying data. The data ID in the killer pattern holding table 112 is the same as the data ID in the data pattern holding table 111, and data having the same data ID is the same data. The “data ID” stored in the killer pattern holding table 112 is stored by a killer pattern storing unit 134 which will be described later.

The “BER value” represents the rate of bit errors occurring in data when data corresponding to the data ID is output to the transmission path. For example, “1.4433E-08,” “6.1187E-09” and the like are stored in the “BER value.” As the “BER value” stored in the killer pattern holding table 112, a value received from a user through the input unit 101 is stored by the I/O control unit 131. For example, “E-08” represents “e⁻⁸ (e is a base of natural logarithm).”

The “data size” represents a data size stored in the data pattern holding table 111. For example, “96,” “120,” and the like are stored in the “data size.” The “data size” stored in the killer pattern holding table 112 is stored by the killer pattern storing unit 134 which will be described later.

In the example illustrated in FIG. 3, the killer pattern holding table 112 represents that the data ID of data having the “BER value” of “1.4433E-08” is “0001”, and the data size thereof is “96.”

The monitoring condition setting table 113 stores a monitoring condition used to monitor the BER value of data output by the transmission test device 100. A value, which is received from the user through the input unit 101, is stored in the monitoring condition setting table 113 through the I/O control unit 131. For example, a monitoring condition may be read from a file and set to the monitoring condition setting table 113.

For example, the monitoring condition setting table 113 stores information in which a “BER monitoring interval time,” an “internal monitoring transfer amount,” an “end condition,” and a “BER reference value” are associated with one another as the monitoring condition used to monitor the BER value.

The “BER monitoring interval time” stored in the monitoring condition setting table 113 represents an interval for checking the BER value during data transfer, and for example, “5 (seconds)” is stored as the “BER monitoring interval time.”

The “internal monitoring transfer amount” represents a transfer amount that allows the BER value to be determined as being valid when the BER value is checked. For example, when a single CRC (cyclic redundancy check) error occurs during transfer in which the BER reference value is 10¹² bytes, although no error occurs at 10¹⁰ bytes, the transfer amount is not determined as being sufficient. In this case, transfer of at least 10¹² bytes is preferable, and “10¹² bytes” is stored in the “internal monitoring transfer amount.”

The “end condition” is a value representing a processing end condition, and represents the total transfer amount. For example, “10¹⁴ bytes” is stored in the “end condition.” Alternatively, a test time may be set as the “end condition,” and processing may end when a set time elapses.

The “BER reference value” represents a threshold value used to determine whether or not a data pattern is valid based on a BER value calculated during transfer. For example, “10⁻¹²” representing a rate at which a single CRC error occurs during transfer of 10¹² bytes is stored in the “BER reference value.” Here, the data pattern is determined as being valid when the BER value is high, whereas the data pattern is determined as being invalid when the BER value is low.

The previous BER value holding unit 114 stores a previously measured BER value. The previous BER value stored in the previous BER value holding unit 114 is stored by a determining unit 133. Further, “0 (zero)” is stored in the previous BER value holding unit 114 as an initial setting value.

The SerDes circuit 120 includes a scramble converting unit 121, a data transfer unit 122, a BER register 123, and a data transfer amount register 124, and controls an exchange of data between the transmission test device 100 and the information processing apparatus 200. For example, the SerDes circuit 120 is the Ethernet (a registered trademark), the PCI-Express (a registered trademark), the InfiniBand (a registered trademark), or the like.

The scramble converting unit 121 performs scramble conversion of data when the BER value is higher than a predetermined reference value.

The data transfer unit 122 converts parallel data input from the control unit 130 into serial data and outputs the serial data to the bus 150, and converts serial data input from the bus 150 into parallel data and outputs the parallel data to the control unit 130.

The BER register 123 holds the BER value on data output from the data transfer unit 122. For example, the BER register 123 holds “3.3862E-10” as the BER value.

The data transfer amount register 124 represents a data amount transferred by the data transfer unit 122. For example, the data transfer amount register 124 holds “10¹⁰ bytes” as the data amount.

Referring back to FIG. 1, the control unit 130 includes the I/O control unit 131, a killer pattern transfer unit 132, the determining unit 133, the killer pattern storing unit 134, and a data change unit 135. The control unit 130 includes an internal memory for storing a control program, a program specifying various processing procedures and the like, and data. For example, the control unit 130 includes an electronic circuit such as an ASIC (Application Specific Integrated Circuit) or an FPGA (Field Programmable Gate Array) or an electronic circuit such as a CPU (Central Processing Unit) or an MPU (Micro Processing Unit).

The I/O control unit 131 sets various setting values received from the user through the input unit 101 to the storage unit 110. Further, the I/O control unit 131 outputs a test result, a variety of data, and the like, which are generated in the control unit 130, to the output unit 102.

The killer pattern transfer unit 132 acquires the data pattern from the data pattern holding table 111, and outputs the acquired data pattern to the SerDes circuit 120. For example, the killer pattern transfer unit 132 reads one of data patterns stored in the killer pattern holding table 112 in descending order, and then acquires data matching the “data ID” of the read data pattern from the data pattern holding table 111. Then, the killer pattern transfer unit 132 outputs the acquired data to the SerDes circuit 120.

Further, the killer pattern transfer unit 132 reads data decided by the data change unit 135 from the killer pattern holding table 112. Then, the killer pattern transfer unit 132 acquires data matching the “data ID” of the read data pattern from the data pattern holding table 111, and then outputs the acquired data pattern to the SerDes circuit 120.

When the BER monitoring interval time set to the monitoring condition setting table 113 has elapsed, the determining unit 133 acquires the BER value held in the BER register 123, and determines whether or not data is valid for the transmission test based on the acquired BER value. For example, the determining unit 133 determines whether or not the acquired BER value is larger than the set BER reference value.

When it is determined that the acquired BER value is larger than the BER reference value, the determining unit 133 determines whether or not the end condition of the transmission test has been satisfied. For example, the determining unit 133 determines whether or not a total transfer amount or a time is larger than a setting value as the end condition of the transmission test. Here, when it is determined that a total transfer amount or time has satisfied the end condition, the determining unit 133 ends the transmission test. However, when it is determined that the total transfer amount or time has not satisfied the end condition, the determining unit 133 is on standby until the set BER monitoring interval time elapses, and then determines whether or not data is valid for the transmission test again.

When it is determined that the acquired BER value is not larger than the BER reference value, the determining unit 133 determines whether or not data is to be changed. The determining unit 133 reads the previous BER value from the previous BER value holding unit 114, compares the acquired BER value with the previous BER value, and determines whether or not the acquired BER value is smaller than the previous BER value. When it is determined that the acquired BER value is smaller than the previous BER value by comparing the acquired BER value with the previous BER value, the determining unit 133 causes the data change unit 135 to execute a transfer data change process.

When it is determined that the acquired BER value is not smaller than the previous BER value, the determining unit 133 updates the previous BER value stored in the previous BER value holding unit 114 to the acquired BER value. Then, the determining unit 133 reads the data transfer amount from the data transfer amount register 124, and then determines whether or not the data transfer amount is larger than the internal monitoring transfer amount. Here, when it is determined that the data transfer amount is larger than the internal monitoring transfer amount, the determining unit 133 then determines whether or not a end condition of a continuation test has been satisfied. However, when it is determined that the data transfer amount is not larger than the internal monitoring transfer amount, the determining unit 133 causes the data change unit 135 to execute the transfer data change process.

After transmitting a notice causing the data change unit 135 to execute the transfer data change process, the determining unit 133 then determines whether or not the end condition of the continuation test has been satisfied.

The killer pattern storing unit 134 stores a designated data pattern among the data patterns stored in the data pattern holding table 111 in the killer pattern holding table 112. Further, for example, when power is turned on, the killer pattern storing unit 134 according to the first embodiment stores all of the data patterns stored in the data pattern holding table 111 in the killer pattern holding table 112 by associating with the “data ID” and the “data size.” Further, when the “BER value” is input, the killer pattern storing unit 134 causes the killer pattern holding table 112 to rearrange the “BER values” in descending order.

When the determining unit 133 determines that the BER value read from the BER register 123 is smaller than the previous BER value as a result of comparison, the data change unit 135 executes the change process on data output to the SerDes circuit 120 through the killer pattern transfer unit 132.

When the determining unit 133 determines that the data transfer amount is larger than the internal monitoring transfer amount, or when the determining unit 133 determines that the BER value is smaller than the previous BER value, the data change unit 135 executes the data pattern change process.

For example, the data change unit 135 selects one killer pattern next to the current killer pattern in the killer pattern holding table 112 from the killer pattern holding table 112 in descending order, and then reads the BER value of the selected killer pattern. Then, the data change unit 135 determines whether or not the read BER value is higher than a BER reference value set by a driving condition.

Here, when it is determined that the read BER value is higher than the BER reference value set to the monitoring condition setting table 113, the data change unit 135 decides the selected killer pattern as transfer data. However, when it is determined that the read BER value is not higher than the BER reference value designated by the driving condition, the data change unit 135 decides a data pattern at the head of the killer pattern holding table 112 as the transfer data. The data change unit 135 notifies the killer pattern transfer unit 132 of the decided transfer data.

Processing Procedure of Processing by Transmission Test Device According to First Embodiment

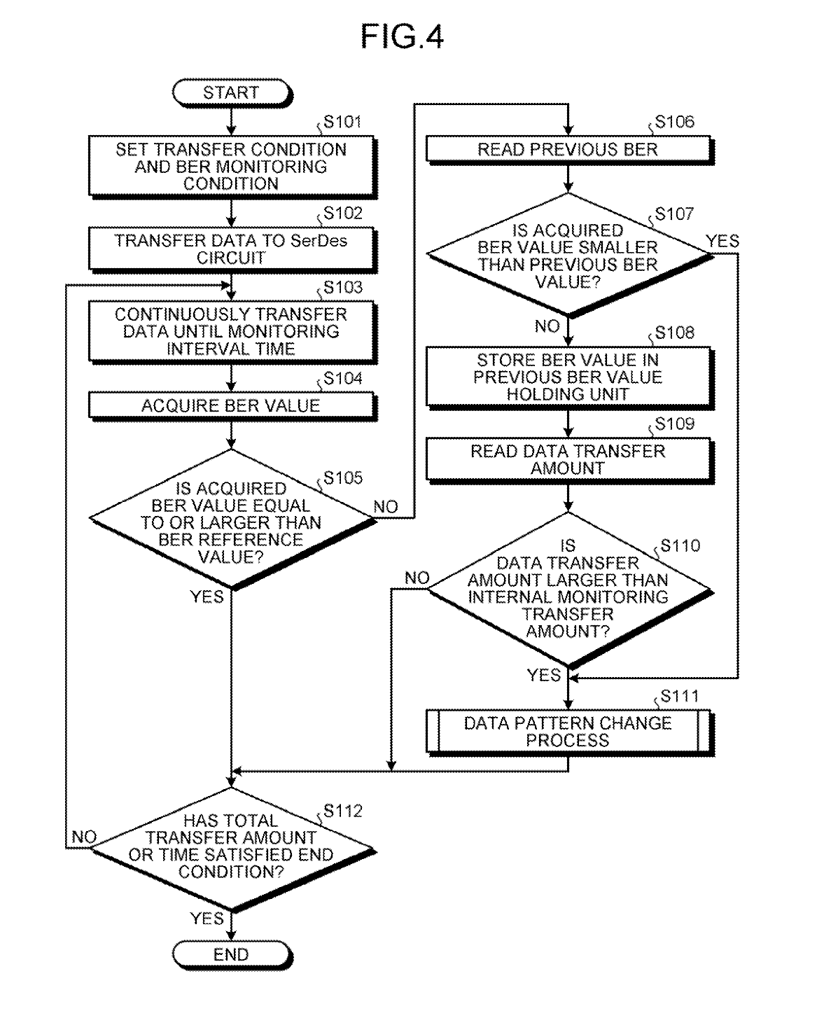

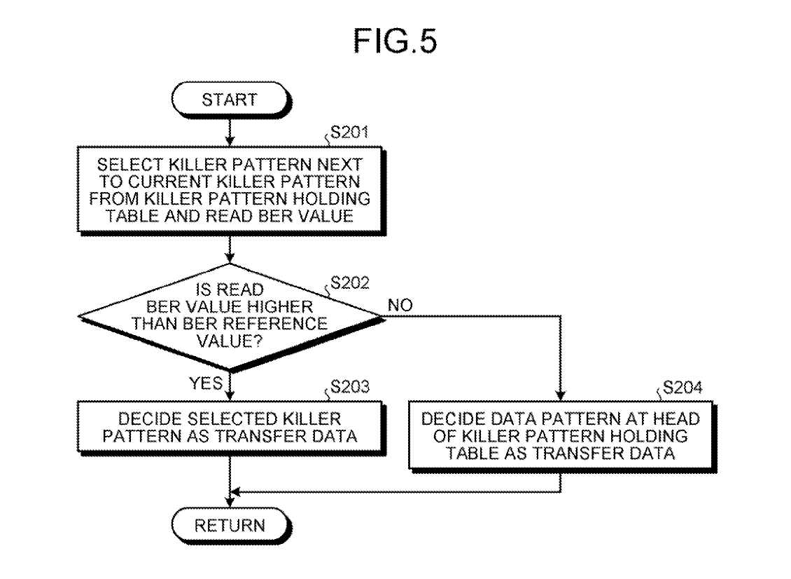

Next, a processing procedure of processing performed by the transmission test device according to the first embodiment will be described with reference to FIGS. 4 and 5. Here, a continuation test process will be described with reference to FIG. 4, and a killer pattern change process will be described with reference to FIG. 5.

Continuation Test Process of Killer Pattern

FIG. 4 is a flowchart illustrating a processing procedure of a continuation test process of a killer pattern performed by the transmission test device according to the first embodiment. As illustrated in FIG. 4, the I/O control unit 131 receives setting information about a transfer condition and a BER monitoring condition (step S101). Then, the killer pattern transfer unit 132 acquires data from the data pattern holding table 111, and then transfer the acquired data to the SerDes circuit (step S102).

The determining unit 133 continuously transfers the data until the monitoring interval time (step S103), and then acquires the BER value from the BER register 123 (step S104). Then, the determining unit 133 compares the BER reference value with the acquired BER value and determines whether or not the acquired BER value is larger than the BER reference value (step S105).

Here, when it is determined that the acquired BER value is not larger than the BER reference value (No in step S105), the determining unit 133 reads the previous BER value from the previous BER value holding unit 114 (step S106). Then, the determining unit 133 compares the acquired BER value with the previous BER value and determines whether or not the acquired BER value is smaller than the previous BER value (step S107).

Here, when it is determined that the acquired BER value is not smaller than the previous BER value (No in step S107), the determining unit 133 stores the acquired BER value in the previous BER value holding unit 114 (step S108). Then, the determining unit 133 reads the data transfer amount from the data transfer amount register 124 (step S109). The determining unit 133 determines whether or not the data transfer amount is larger than the internal monitoring transfer amount (step S110).

Here, when the determining unit 133 determines that the data transfer amount is larger than the internal monitoring transfer amount (Yes in step S110) or when the determining unit 133 determines that the acquired BER value is smaller than the previous BER value (Yes in step S107), the data change unit 135 executes the following process. In other words, the data change unit 135 executes the data pattern change process (step S111).

Meanwhile, when it is determined that the acquired BER value is larger than the BER reference value (Yes in step S105), when it is determined that the data transfer amount is not larger than the internal monitoring transfer amount (No in step S110), or after processing of step S111 ends, the determining unit 133 executes the following process. In other words, the determining unit 133 determines whether or not the total transfer amount or time has satisfied the end condition (step S112).

Here, when it is determined that the total transfer amount or time has not satisfied the end condition (No in step S112), the determining unit 133 causes the process to proceed to step S103. However, when it is determined that the total transfer amount or time has satisfied the end condition (Yes in step S112), the determining unit 133 ends the process.

Killer Pattern Change Process

FIG. 5 is a flowchart to describe a processing procedure of the killer pattern change process performed by the transmission test device according to the first embodiment. Here, this process corresponds to step S111 illustrated in FIG. 4. As illustrated in FIG. 5 the data change unit 135 selects a killer pattern next to the current killer pattern from the killer pattern holding table 112 in descending order, and then reads the BER value of the selected killer pattern (step S201).

Then, the data change unit 135 determines whether or not the read BER value is higher than the BER reference value set to the monitoring condition setting table 113 (step S202). Here, when it is determined that the read BER value is higher than the BER reference value (Yes in step S202), the data change unit 135 decides the selected killer pattern as the transfer data (step S203). However, when it is determined that the read BER value is not higher than the BER reference value (No in step S202), the data change unit 135 decides a data pattern at the head of the killer pattern holding table 112 as the transfer data (step S204).

After processing of step S203 or processing of step S204 ends, the data change unit 135 ends the killer pattern change process.

Effects of First Embodiment

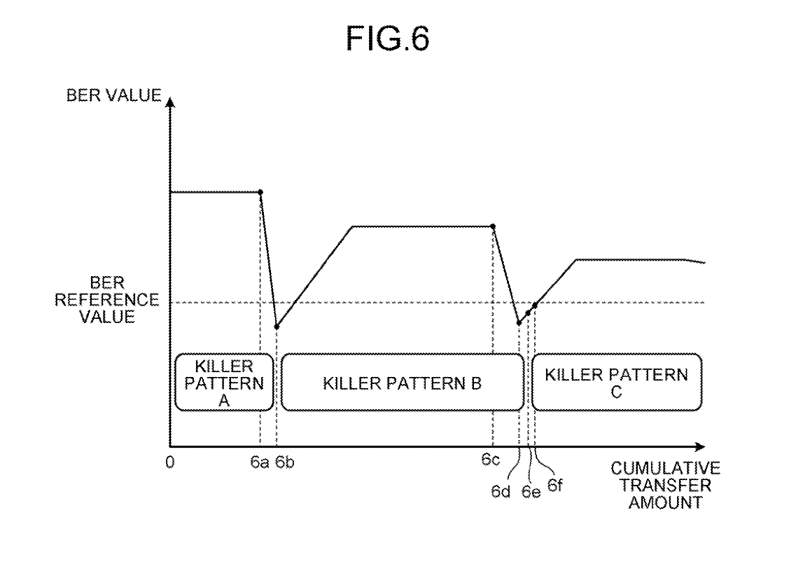

Next, effects of the transmission test device according to the first embodiment will be described with reference to FIG. 6. FIG. 6 is a diagram illustrating an example of a relation between BER transition in scramble conversion and the killer pattern change process. In FIG. 6, a horizontal axis represents a data transfer amount, and a vertical axis represents a BER value.

As illustrated in FIG. 6, when the transmission test device 100 transfers a killer pattern A, scramble conversion is executed at a point in time when the cumulative transfer amount of the killer pattern becomes 6a, and thereafter the BER value decreases. Then, the transmission test device 100 determines that the BER value is smaller than the reference value at a point in time when the cumulative transfer amount of the killer pattern becomes 6b, and thus changes a killer pattern from the killer pattern A to a killer pattern B. As a result, thereafter, the BER value increases.

Further, when scramble conversion is executed at a point in time when the cumulative transfer amount of the killer pattern becomes 6c and thereafter the BER value decreases, the transmission test device 100 determines that the BER value is smaller than the reference value at a point in time when the cumulative transfer amount of the killer pattern becomes 6d, and thus changes a killer pattern from the killer pattern B to a killer pattern C. As a result, thereafter, the BER value increases.

As described above, the transmission test device 100 determines whether or not the BER value is smaller than the reference value, and then changes the killer pattern when the BER value is smaller than the reference value. Thus, even in the SerDes circuit in which scramble conversion is executed, the transmission test can be continuously performed. As a result, a defective product can be accurately detected, and the outflow of a defective product can be prevented.

Further, in the related art, when a killer pattern is changed at regular intervals during a predetermined time period, a time until transition to a next killer pattern is made directly after transition from a killer pattern to a stable pattern is made is wasted for a test. However, the transmission test device 100 according to the present disclosure can dynamically change the killer pattern based on the acquired BER value and thus can reduce a time taken until transition to a next killer pattern is made.

Further, when the acquired BER value is smaller than the reference value, the transmission test device 100 reads the previous BER value, compares the read previous BER value with the acquired BER value, and determines whether or not the acquired BER value is smaller than the previous BER value. Further, when it is determined that the acquired BER value is not smaller than the previous BER value, the transmission test device 100 transfers the killer pattern until the data transfer amount exceeds the internal monitoring transfer amount. As a result, even when the BER value decreases to be smaller than the reference value directly after the killer pattern is changed, the killer pattern change process is not immediately performed, and the killer pattern can be continuously transferred until the BER value exceeds the reference value. In the example illustrated in FIG. 6, when the previous BER value is measured at a point 6e, even though the BER value at a point 6f is smaller than the reference value, the killer pattern can be continuously transferred until the BER value increases without changing the killer pattern.

Further, even when the acquired BER value is larger than the reference value, the transmission test device 100 may stores the acquired reference value as the previous BER value. Further, when it is determined that the acquired BER value is larger than the reference value but smaller than the previous BER value, the killer pattern change process may be executed. As a result, the transmission test can be performed in a state in which the BER value constantly remains to be larger than the reference value.

The first embodiment has been described in connection with the example in which the transmission test is performed using data which is transferred from the transmission test device 100 to the information processing apparatus 200. However, the invention is not limited to this example. For example, a test can be performed inside an own device such that a SerDes circuit at a transmission side is connected with a SerDes circuit at a reception side to implement loopback. As a result, for example, it is possible to a case in which few errors are found in the SerDes circuit at the transmission side, but many errors are found in the SerDes circuit at the reception side.

### [b] Second Embodiment

The first embodiment has been described in connection with the example in which the continuation test process is executed using a previous registered killer pattern. Further, in the first embodiment, the BER value is measured and then compared with the reference value to determine whether or not to change the killer pattern. The process of measuring the BER value and comparing the BER value with the reference value can be applied to a search for data which can be newly used as a killer pattern in addition to the existing killer pattern.

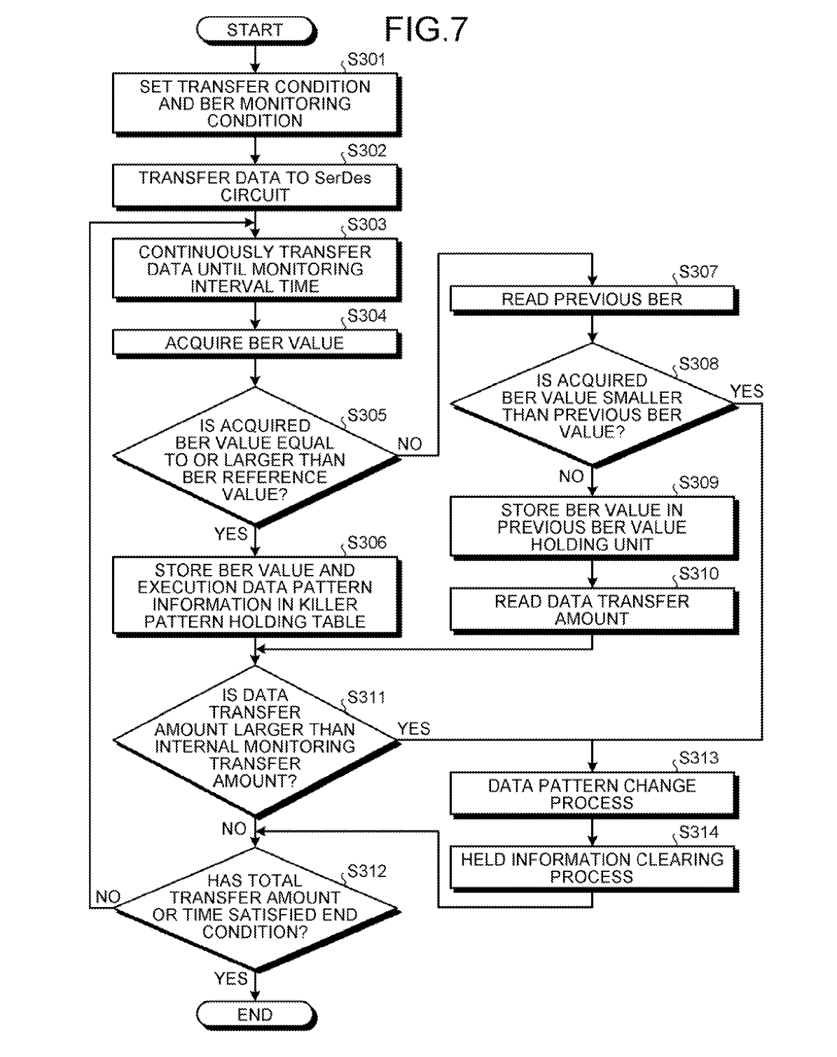

In this regard, a second embodiment will be described in connection with an example in which data that can be as a killer pattern is extracted from among a plurality of data patterns. In the following, a configuration of a transmission test device, the flow of processing performed by a transmission test device, effects, and the like will be described with reference to FIGS. 1 and 7.

Configuration of Transmission Test Device According to Second Embodiment

In the following, the same function as in the transmission test device according to the first embodiment will not be described, and a description will proceed in connection with a function different from the transmission test device according to the first embodiment. Further, components having the same name will be denoted by the same reference numerals.

A data pattern holding table 111 according to the second embodiment stores a “data ID” and a “data array” of a data pattern used by a transmission test device 100 in association with each other. For example, it is assumed that the data pattern holding table 111 according to the second embodiment stores data including an arbitrary array. The data pattern stored in the data pattern holding table 111 according to the second embodiment may include a well-known killer pattern.

A killer pattern holding table 112 stores a BER value, a start address at which a data pattern is stored, and a data size of a data pattern extracted as a killer pattern among data patterns in association with one another. Further, it is assumed that data of the killer pattern holding table 112 according to the second embodiment does not remain stored when power is turned on, and the killer pattern holding table 112 is generated by a killer pattern storing unit 134 when data which can be a killer pattern is extracted from among a plurality of data patterns.

A killer pattern transfer unit 132 according to the second embodiment reads one data pattern from the data pattern holding table 111, and then outputs the read data pattern to a SerDes circuit 120.

A determining unit 133 according to the second embodiment continuously transfers data until the monitoring interval time, and then acquires the BER value from a BER register 123. Then, the determining unit 133 compares the BER reference value with the acquired BER value, and determines whether or not the acquired BER value is larger than the BER reference value.

Here, when it is determined that the acquired BER value is larger than the BER reference value, the determining unit 133 stores the acquired BER value in a previous BER value holding unit 114, and requests the killer pattern storing unit 134 to store data in the killer pattern holding table 112. Then, the determining unit 133 reads a data transfer amount from a data transfer amount register 124, and then determines whether or not the data transfer amount is larger than an internal monitoring transfer amount.

Here, when the determining unit 133 determines that the BER value of the transferred data pattern is larger than the reference value, the killer pattern storing unit 134 according to the second embodiment stores the acquired BER value in the killer pattern holding table 112 in association with the data ID and the data size.

A data change unit 135 according to the second embodiment changes the data pattern when the determining unit 133 determines that the data transfer amount is larger than the internal monitoring transfer amount or when the determining unit 133 determines that the acquired BER value is smaller than the previous BER value. Then, the data change unit 135 clears information stored in the previous BER value holding unit 114.

Processing Procedure of Processing by Transmission Test Device According to Second Embodiment

Next, a processing procedure of a killer pattern extracting process performed by the transmission test device according to the second embodiment will be described with reference to FIG. 7. FIG. 7 is a flowchart illustrating a processing procedure of the killer pattern extracting process performed by the transmission test device according to the second embodiment.

As illustrated in FIG. 7, the I/O control unit 131 receives setting information about a transfer condition and a BER monitoring condition (step S301). Then, the killer pattern transfer unit 132 acquires data from the data pattern holding table 111, and then transfers the acquired data to the SerDes circuit (step S302).

The determining unit 133 continuously transfer the data until the monitoring interval time (step S303), and then acquires the BER value from the BER register 123 (step S304). Then, the determining unit 133 compares the BER reference value with the acquired BER value, and determines whether or not the acquired BER value is larger than the BER reference value (step S305).

Here, when it is determined that the acquired BER value is larger than the BER reference value (Yes in step S305), the determining unit 133 executes the following process. In other words, the determining unit 133 stores the acquired BER value in the previous BER value holding unit 114, and stores data in the killer pattern holding table 112 through the killer pattern storing unit 134 (step S306).

However, when it is determined that the acquired BER value is not larger than the BER reference value (No in step S305), the determining unit 133 reads the previous BER value from the previous BER value holding unit 114 (step S307). Then, the determining unit 133 compares the acquired BER value with the previous BER value, and determines whether or not the acquired BER value is smaller than the previous BER value (step S308).

Here, when it is determined that the acquired BER value is not smaller than the previous BER value (No in step S308), the determining unit 133 stores the acquired BER value in the previous BER value holding unit 114 (step S309).

After processing of step S309 ends, the determining unit 133 reads the data transfer amount from the data transfer amount register 124 (step S310). Then, after processing of step S306 or processing of step S310 ends, the determining unit 133 determines whether or not the data transfer amount is larger than the internal monitoring transfer amount (step S311).

Here, when it is determined that the data transfer amount is not larger than the internal monitoring transfer amount (No in step S311), the determining unit 133 determines whether or not the total transfer amount or time has satisfied the end condition (step S312). Here, when it is determined that the total transfer amount or time has not satisfied the end condition (No in step S312), the determining unit 133 cause the process to proceed to step S303. However, when it is determined that the total transfer amount or time has satisfied the end condition (Yes in step S312), the determining unit 133 ends the process.

However, when the determining unit 133 determines that the data transfer amount is larger than the internal monitoring transfer amount (Yes in step S311) or when the determining unit 133 determines that the acquired BER value is smaller than the previous BER value (Yes in step S308), the data change unit 135 executes the following process. In other words, the data change unit 135 changes the data pattern (step S313), and then clears information stored in the previous BER value holding unit 114 (step S314). Then, after processing of step S314 ends, the determining unit 133 executes processing of step S312.

Effects of Second Embodiment

As described above, in the second embodiment, a killer pattern having the BER value larger than the reference value can be extracted. Furthermore, a new killer pattern can be searched from among registered data patterns.

### [c] Third Embodiment

The first embodiment has been described in connection with the example in which the continuation test process is executed using the previously registered killer pattern. Further, the second embodiment has been described in connection with the example in which the process of extracting the killer pattern is executed. As described above, the continuation test process and the killer pattern extracting process are performed independently of each other but may be executed as a series of processes.

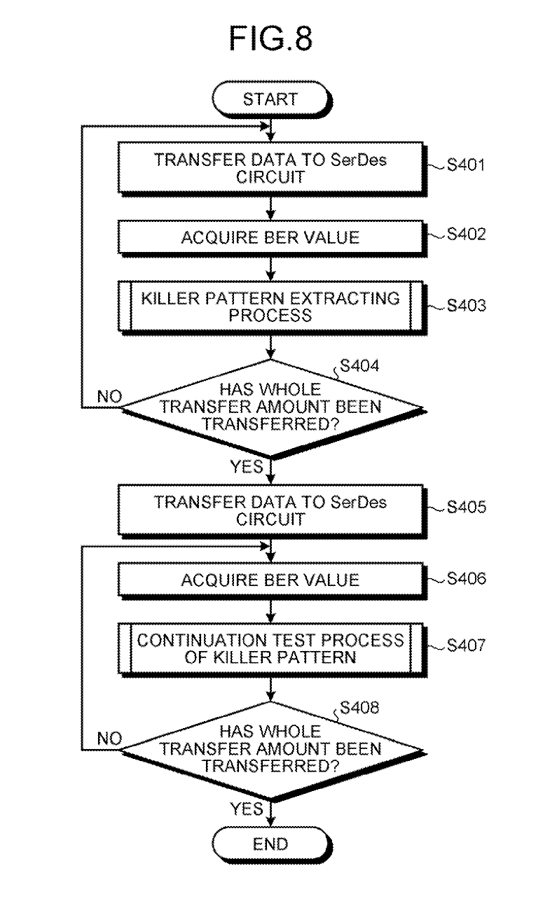

In this regard, a third embodiment will be described in connection with an example in which the process of extracting the killer pattern is executed, and then the subsequent continuation test process is executed. In the following, a configuration of a transmission test device, the flow of processing performed by a transmission test device, effects, and the like will be described with reference to FIGS. 1 and 8.

Configuration of Transmission Test Device According to Third Embodiment

The transmission test device according to the third embodiment has the same configuration as the transmission test device according to the first embodiment and the second embodiment. In other words, when the process of extracting the killer pattern is executed, the same operation as the transmission test device according to the second embodiment is executed, and when the continuation test process is executed, the same operation as the transmission test device according to the first embodiment is executed. Thus, a detailed description of the configuration of the transmission test device according to the third embodiment will not be made.

Extracting and Continuation Test Process by Transmission Test Device According to Third Embodiment

FIG. 8 is a flowchart illustrating a processing procedure of processing performed by the transmission test device according to the third embodiment. As illustrated in FIG. 8, the killer pattern transfer unit 132 transfers data to the SerDes circuit (step S401). Here, the killer pattern transfer unit 132 reads a data pattern from the data pattern holding table 111 that stores data having an arbitrary array, and then outputs the read data pattern to the SerDes circuit 120. Then, the determining unit 133 acquires a BER value (step S402).

Subsequently, the determining unit 133 executes the killer pattern extracting process based on the acquired BER value (step S403). In this processing, processing of each of steps S305 to S311, S313, and S314 illustrated in FIG. 7 is executed, and the killer pattern holding table 112 is generated.

Then, the determining unit 133 determines whether or not the whole transfer amount has been transferred (step S404). Here, when the determining unit 133 determines that the whole transfer amount has not been transferred (No in step S404), the killer pattern transfer unit 132 transfers data to the SerDes circuit (step S401).

However, when the determining unit 133 determines that the whole transfer amount has been transferred (Yes in step S404), data is transferred to the SerDes circuit (step S405). Here, the killer pattern transfer unit 132 reads one of data patterns stored in the killer pattern holding table 112 in descending order, and acquires data matching the “data ID” of the read data pattern from the data pattern holding table 111. Then, the killer pattern transfer unit 132 outputs the acquired data to the SerDes circuit 120.

After step S405 ends, the determining unit 133 acquires the BER value (step S406). Then, the determining unit 133 executes the continuation test process of the killer pattern based on the acquired BER value (step S407). In this processing, processing of each of steps S105 to S111 illustrated in FIG. 4 is executed.

After processing of step S407 ends, the determining unit 133 determines whether or not the whole transfer amount has been transferred (step S408). Here, when the determining unit 133 determines that the whole transfer amount has been transferred (Yes in step S408), the process ends. However, when the determining unit 133 determines that the whole transfer amount has not been transferred (NO in step S408), the process proceeds to step S406.

As described above, the transmission test device according to the third embodiment can execute the killer pattern extracting process and then execute the subsequent continuation test process.

### [d] Fourth Embodiment

The present invention may be embodied in various forms other than the above embodiments. In this regard, a fourth embodiment will be described in connection with another embodiment example of the present invention.

System Configuration and Like

Further, among the processes described in this embodiment, all or some of the processes described to be automatically performed may be manually performed. Alternatively, all or some of the processes described to be manually performed may be automatically performed by a well-known method. In addition, a processing procedure, a control procedure, and a concrete name, which are described in this specification or illustrated in the drawings, can be arbitrarily changed unless specified otherwise.

Further, information stored in a storage unit illustrated in the drawings is merely an example, and information needs not necessarily be stored as illustrated in the drawings. For example, the killer pattern holding table 112 may store an average value in association with other values as the BER value. Further, the monitoring condition setting table 113 may store each data ID in association with the monitoring condition.

Further, an order of processing in each step of each process described in each embodiment may be changed according to various loads, a use condition, and the like. For example, an order of step S313 and step S314 illustrated in FIG. 7 may be switched.

Further, each component illustrated in the drawings needs not necessarily be physically configured as illustrated in the drawings. For example, in the transmission test device 100, the killer pattern transfer unit 132 may be integrated with the data change unit 135. Further, the transmission test device according to the present disclosure can be implemented in another form as long as the transmission test device includes the SerDes circuit 120 and the control unit 130. For example, the transmission test device may be an information processing apparatus such as a server or a personal computer (PC).

Further, all or any part of processing functions performed by the respective devices may be implemented by a CPU and a program analyzed and executed by the CPU or may be implemented as hardware by a wired logic.

Program

A variety of processing described in the above embodiments may be implemented by executing a prepared program through a computer system such as a personal computer or a workstation. In this regard, in the following, the description will proceed in connection with an example of a computer system that executes a program having the same functions as in the above embodiments.

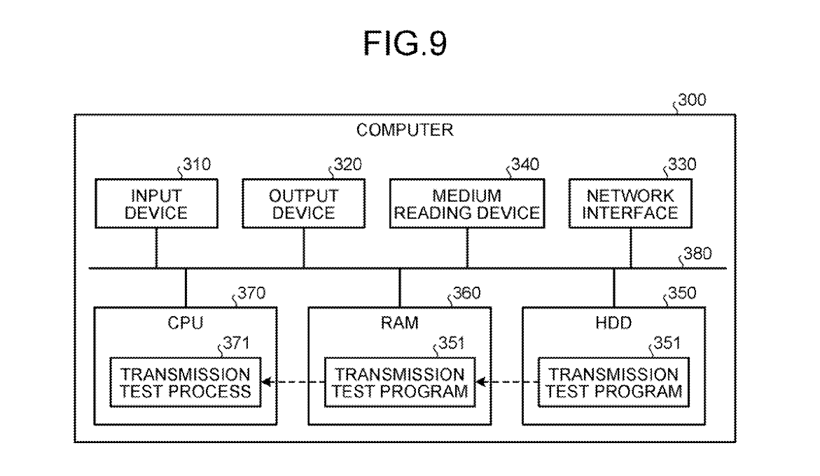

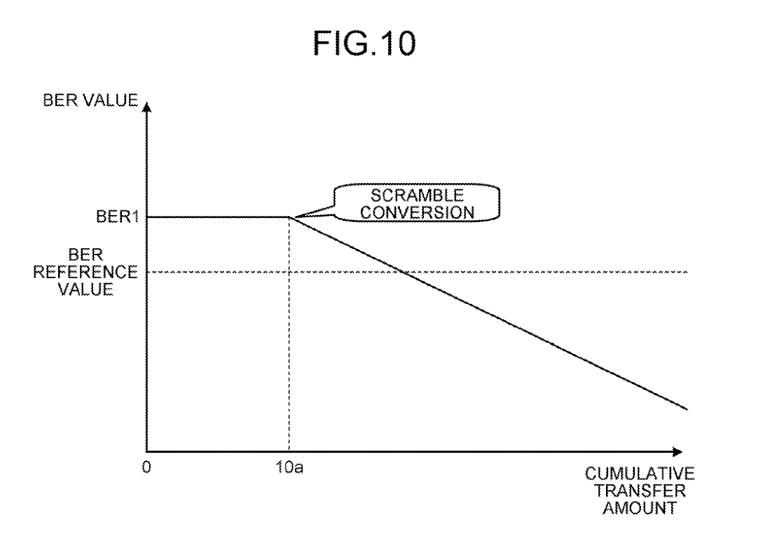

FIG. 9 is a diagram illustrating an example of a computer that executes a transmission test program. As illustrated in FIG. 9, a computer 300 includes an input device 310 that receives data, various settings, and the like from the user, and an output device 320 that notifies of a status of the computer or the like. The computer 300 further includes a network interface 330 that performs transmission and reception of data with another device, a medium reading device 340, a HDD (Hard Disk Drive) 350, a RAM (Random Access Memory) 360, a CPU 370, and a bus 380. Then, each of the devices 310 to 370 is connected to the bus 380.

Here, as illustrated in FIG. 9, a transmission test program 351 is stored in the HDD 350 in advance, and the transmission test program 351 has the same function as the killer pattern transfer unit 132, the determining unit 133, the killer pattern storing unit 134, and the data change unit 135, which are illustrated in FIG. 1. The medium reading device 340 stores a variety of data used to implement the transmission test program 351. Then, the CPU 370 reads the transmission test program 351 from the HDD 350, and implements a transmission test process 371. In other words, the transmission test process 371 executes the same operations of the killer pattern transfer unit 132, the determining unit 133, the killer pattern storing unit 134, and the data change unit 135, which are illustrated in FIG. 1.

Meanwhile, the transmission test program 351 needs not be necessarily stored in the HDD 350. For example, the transmission test program 351 may be stored in a “portable physical medium” such as a flexible disk (FD), a CD-ROM, a MO disk, a DVD disk, an optical magnetic disk, or an IC card, which are inserted into the computer 300. Alternatively, the transmission test program 351 may be stored in a “fixed physical medium” such as a HDD provided outside the computer 300. Furthermore, the transmission test program 351 may be stored in another computer system connected to the computer 300 via a public line, the Internet, a LAN (Local Area Network), a WAN (Wide Area Network), or the like. Then, the computer 300 may read from the above devices and then execute the program.

In other words, the program is stored in a recording medium such as the “portable physical medium,” the “fixed physical medium,” or the “communication medium” in a computer readable form. Then, the computer 300 implements the same functions as in the above embodiments by reading the program from the recording medium and then executing the program. In another embodiment example, the program is not limited to one which is executed by the computer 300. For example, even when the program is executed by another computer system or a server or even when the program is executed by cooperation of another computer system and a server, the present invention can be applied in the same way.

It is possible to continuously incur an error in a transmission path.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission test device that performs a transmission test in a transmission path, the transmission test device comprising:
a memory; and
a processor coupled to the memory, wherein the processor executes a process comprising:
acquiring an abnormality incidence rate representing a rate of abnormality having occurred in test data in a transmission path;
determining whether or not the abnormality incidence rate is lower than a predetermined reference value;
changing the test data when it is determined that the abnormality incidence rate is lower than the predetermined reference value; and
transmitting the changed test data.

2. The transmission test device according to claim 1, wherein
the determining includes, when it is determined the abnormality incidence rate is lower than the predetermined reference value, determining whether or not the acquired abnormality incidence rate is lower than a previously acquired abnormality incidence rate stored in the memory that stores a previously acquired abnormality incidence rate, and
the changing includes, when it is determined that the acquired abnormality incidence rate is not lower than the previously acquired abnormality incidence rate, changing the test data after data of a predetermined transfer amount is transmitted.

3. A transmission test device that performs a transmission test in a transmission path, the transmission test device comprising:
a memory; and
a processor coupled to the memory, wherein the processor executes a process comprising:
acquiring an abnormality incidence rate representing a rate of abnormality having occurred in data in a transmission path;
determining whether or not the abnormality incidence rate is higher than a predetermined reference value; and
selecting the data as test data when it is determined that the abnormality incidence rate is higher than the predetermined reference value.

4. The transmission test device according to claim 3, wherein the process further comprising
changing test data when it is determined that the abnormality incidence rate is lower than the predetermined reference value; and
transmitting the changed test data.

5. A transmission test method comprising:
acquiring an abnormality incidence rate representing a rate of abnormality having occurred in test data in a transmission path, using a processor;
determining whether or not the abnormality incidence rate is lower than a predetermined reference value, using the processor;
changing the test data when it is determined that the abnormality incidence rate is lower than the predetermined reference value, using the processor; and
transmitting the changed test data, using the processor.

6. The transmission test method according to claim 5, wherein
the determining includes, when the abnormality incidence rate is lower than the predetermined reference value, determining whether or not the acquired abnormality incidence rate is lower than a previously acquired abnormality incidence rate stored in the memory that stores a previously acquired abnormality incidence rate, and
the changing includes, when it is determined that the acquired abnormality incidence rate is not lower than the previously acquired abnormality incidence rate, changing the test data after data of a predetermined transfer amount is transmitted.

7. A computer-readable storage medium having stored therein a transmission test program causing a computer to perform:
acquiring an abnormality incidence rate representing a rate of abnormality having occurred in test data in a transmission path;
determining whether or not the abnormality incidence rate is lower than a predetermined reference value;
changing the test data when it is determined that the abnormality incidence rate is lower than the predetermined reference value, using the processor; and
transmitting the changed test data.

8. The computer-readable storage medium according to claim 7, wherein
the determining includes, when the abnormality incidence rate is lower than the predetermined reference value, determining whether or not the acquired abnormality incidence rate is lower than a previously acquired abnormality incidence rate stored in the memory that stores a previously acquired abnormality incidence rate, and
the changing includes, when it is determined that the acquired abnormality incidence rate is not lower than the previously acquired abnormality incidence rate, changing the test data after data of a predetermined transfer amount is transmitted.
